(19) United States
(12) Patent Application Publication
(10) Pub. No.: US 2017/0173567 A1
(43) Pub. Date: Jun. 22, 2017

(54) METHOD OF PREPARING SELECTIVE CATALYTIC REDUCTION COMPOSITE CATALYST

(71) Applicant: National Chiao Tung University, Hsinchu City (TW)

(72) Inventors: Hsun-Ling Bai, Taichung City (TW); Liang-Yi Lin, New Taipei City (TW); Tsung-Yu Lee, Tainan City (TW); You-Ren Zhang, Yunlin County (TW)

(21) Appl. No.: 15/068,655

(22) Filed: Mar. 14, 2016

(30) Foreign Application Priority Data
Dec. 16, 2015 (TW) 104142247

(51) Int. Cl. B01J 23/889; B01J 37/02; B01J 37/08; B01J 21/06

(52) U.S. Cl. CPC B01J 23/8892; B01J 21/063; B01J 37/0221; B01J 37/0236; B01J 37/08

(57) ABSTRACT

A method of preparing selective catalytic reduction composite catalyst is provided. First, first metal compound support, second metal compound, third metal compound and water are mixed to formed a precursor solution. Then, dried mixture powder is formed from the precursor solution by a spray-drying process. Thereafter, a calcination process is performed on the dried mixture powder.

### CROSS-REFERENCE TO RELATED APPLICATION

This application claims the priority benefit of Taiwan application serial no. 104142247, filed on Dec. 16, 2015. The entirety of the above-mentioned patent application is hereby incorporated by reference herein and made a part of this specification.

### TECHNICAL FIELD

The present disclosure relates to a method of preparing a catalyst, and particularly relates to a method of preparing a selective catalytic reduction composite catalyst.

### BACKGROUND

In general, the selective catalytic reduction (SCR) catalyst manufacturing technology includes a coprecipitation method, a sol-gel method, a wet impregnation method, a chemical vapor deposition method, and the like. Among them, the coprecipitation method is the most commonly used method for preparing liquid-phase powder. Therefore, the method is used for mass production of powder in industry. In the chemical vapor deposition method, more than one solvent is selected, and the desired ingredient is dissolved in the solvent and uniformly stirred, at an appropriate concentration, pressure, temperature, and fixed pH value, so that the reactant exists in the solution in an ion state. After that, a precipitant (e.g. sodium carbonate, ammonia) is added into the mixed solution and a pH value thereof is adjusted to an appropriate pH value thereby cations in the solution achieves a super-saturation state to precipitate. If there are more than one kind of cation, the cations may precipitate at the same time or within a certain time when adding the precipitant, where the phenomenon is called as coprecipitation. A pH value is an important reaction parameter in the coprecipitation method. The advantages of the coprecipitation method is simple and easy to operate. However, it has the disadvantages, such as lower purity, large particle radius, hard dispersion, incapability of continuously production, and the like. The coprecipitation method is suitable to prepare oxides.

The sol-gel method is based on an inorganic polymerization reaction to prepare inorganic polymer compounds, wherein a metal alkoxide or an inorganic metal compound is used as a precursor, water is used as a hydrolytic agent, and alcohol is used as a solvent. In the solution, the precursor undergoes hydrolysis and condensation to form fine particles, then forms a sol which make fine particles continue reacting to connect together, and the sol is solidified into a gel. The advantages of the sol-gel method are a variety of reactants, uniformity particles of product, easily controllable process, and good particle dispersion. However, it has the disadvantages, such as hard controllable particle size and incapability of continuously production, and the like.

In the impregnation method, a metal precursor is dissolved into a specific solution, and a carrier is mixed with the solution. Next, the carrier is dried and calcinated to complete the preparation of the catalyst, wherein the conditions of a drying temperature, a solution concentration, and stirring of the solution when in contact with the carrier may influence the catalyst activity. The advantage of the impregnation method is simple preparation. However, it has the disadvantages, such as poor dispersion, low purity and incapability of continuously production. In the chemical vapor deposition method, a metal compound in a vapor phase is used for performing a chemical reaction to form a nanoparticle through the nuclear condensation process and the cold condensation process. The advantage of the chemical vapor deposition method is that the product therefrom has a high purity, uniformly particle distribution and is able to continuously produced in a gas phase. However, it has the disadvantages, such as most precursors are compounds which are expensive and harmful for environment, for example, organic metal chloride or alkoxide, and the like.

### SUMMARY

The present disclosure provides a method of preparing a selective catalytic reduction composite catalyst having a simple, fast, and continuously produced operating procedure.

The present disclosure provides a method of preparing a selective catalytic reduction composite catalyst including the following steps. A first metal compound support, a second metal compound, a third metal compound, and water are mixed to form a precursor solution. A dried mixture powder is formed from the precursor solution by a spray-drying process. A calcination process is performed on the dried mixture powder.

In an embodiment of the present disclosure, the selective catalytic reduction composite catalyst includes a manganese-iron-titanium selective catalytic reduction composite catalyst.

In an embodiment of the present disclosure, the first metal compound support includes a titanium oxide support.

In an embodiment of the present disclosure, the titanium oxide support includes titanium hydroxide.

In an embodiment of the present disclosure, a method of forming the titanium oxide support includes mixing water, a titanium oxide hydrated precursor, and ammonia.

In an embodiment of the present disclosure, the second metal compound includes a manganese metal compound.

In an embodiment of the present disclosure, the second metal compound includes manganese acetate.

In an embodiment of the present disclosure, the third metal compound includes an iron metal compound.

In an embodiment of the present disclosure, the third metal compound includes ferric nitrate.

In an embodiment of the present disclosure, the spray-drying process includes using a spray-drying device to perform the spray-drying process, wherein the spray-drying device includes a nozzle, a reaction chamber, a particle collector, and a sample collection bottle.

In an embodiment of the present disclosure, the nozzle is used for atomizing the precursor solution into the reaction chamber.

In an embodiment of the present disclosure, further includes injecting a carrier gas into the spray-drying device so as to carry the atomized precursor solution.

In an embodiment of the present disclosure, the carrier gas is a compressed air.

In an embodiment of the present disclosure, a spraying air pressure of the spray-drying device is about from 3 to 5 kg/cm².

In an embodiment of the present disclosure, an inlet temperature of the reaction chamber is about from 150 to 300° C.

In an embodiment of the present disclosure, an outlet temperature of the reaction chamber is about from 105 to 150° C.

In an embodiment of the present disclosure, a liquid feed rate of the nozzle is about from 2 to 5 g/min.

In an embodiment of the present disclosure, a ratio of a solid content to water of the precursor solution is about 1:10.

In an embodiment of the present disclosure, a temperature of the calcination process is about 350° C.

In an embodiment of the present disclosure, a dimension of the selective catalytic reduction composite catalyst is about from 0.5 to 3 mm, and a specific surface area thereof is about from 52 to 74 m²/g.

Based on the above descriptions, the present disclosure uses a spray-drying process having a simple, fast, and continuously produced operating procedure to produce a selective catalytic reduction composite catalyst. Therefore, problems, such as ununiform particles, poor distribution of particles, or incapability of continuously production generally occur in a manufacturing process of selective catalytic reduction composite catalysts may be avoided.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a spray dryer using in a method of preparing a selective catalytic reduction composite catalyst according to an embodiment of the present disclosure.

FIG. 2 is a bar graph of the results of a selective catalytic reduction test, where the Mn—Fe—Ti composite catalysts of Example and Comparative Examples 1-3 of the present disclosure are used.

FIG. 3 is a line graph of the selective catalytic reduction denitrification efficiency of the Mn—Fe—Ti composite catalyst of Example of the present disclosure and the catalysts published by Liu et al. in 2009 and 2013.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

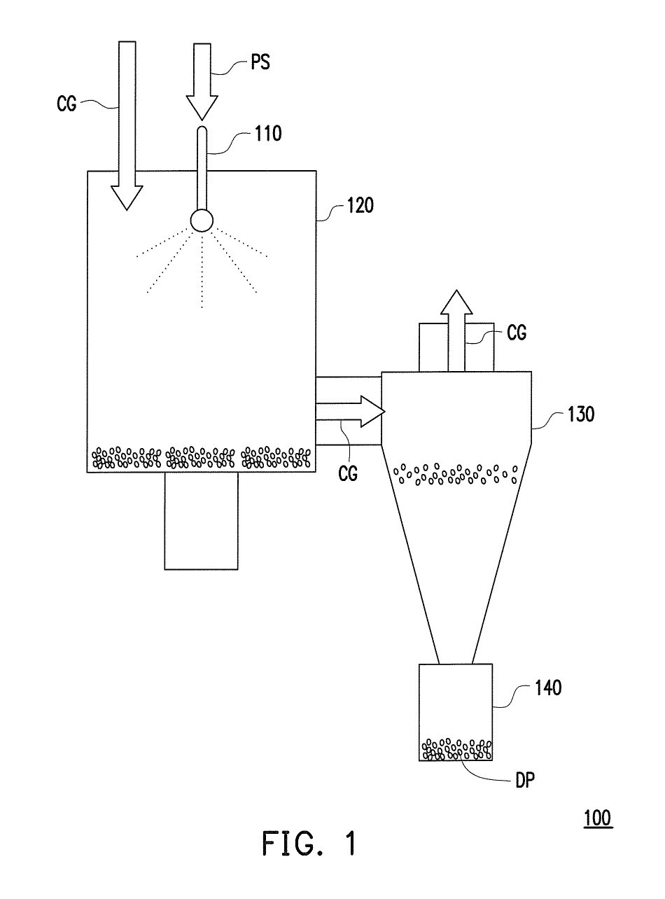

FIG. 1 is a schematic view of a spray dryer of a method of preparing a selective catalytic reduction composite catalyst according to an embodiment of the present disclosure. In the embodiments, first, a first metal compound support, a second metal compound, a third metal compound, and water are mixed to form a precursor solution PS. In the manufacturing process of the SCR catalyst, the first metal compound support is, such as a titanium oxide support, a silicon oxide support, or an aluminum oxide support, and the like. In the embodiments, titanium hydroxide is used as the titanium oxide support. In the embodiments, a method of preparing the titanium oxide support is to uniformly mix and stir titanium metal hydrate powder, water, and ammonia at normal temperature and pressure so as to form a titanium oxide precipitate, and then suction filtration is performed on the titanium oxide precipitate which is also washed by deionized water several times so as to obtain the titanium oxide support, for example. In the embodiments, the titanium metal hydrate is titanium oxide hydrate (TiO(OH)₂), for example. In the manufacturing process of the SCR catalyst, the second metal compound includes a metal compound such as a manganese metal compound, cerium oxide, vanadium oxide, etc. In the embodiments, manganese acetate is used as the second metal compound, and a concentration thereof is, for example, from 5 wt % to 30 wt %, such as 5 wt %, 10 wt %, 15 wt %, 20 wt %, 25 wt %, or 30 wt %. In the manufacturing process of the SCR catalyst, the third metal compound includes a metal compound, such as an iron metal compound, cobalt oxide, nickel oxide, etc., and noble metal, such as gold, silver, etc. In the embodiments, ferric nitrate is used as the third metal compound, and a concentration thereof is, for example, from 5 wt % to 20 wt %, such as 5 wt %, 10 wt %, 15 wt %, or 20 wt %. In the embodiments, water is deionized water, for example. In the embodiments, the first metal compound support, the second metal compound, the third metal compound, and water are uniformly stirred and mixed at normal temperature to form the precursor solution PS, for example. In the embodiments, the precursor solution PS is a Mn—Fe—Ti acidic aqueous solution, for example. In the embodiments, a ratio of a solid content to water of the precursor solution PS is about 1:10, for example. That is, a ratio of the first metal compound support, the second metal compound, and the third metal compound to water is about 1:10, for example.

Referring to FIG. 1, then, by a spray-drying process, a dried mixture powder DP is formed from the precursor solution PS. In the embodiments, the spray-drying process is performed in a spray-drying device 100, for example. The spray-drying device 100 includes a nozzle 110, a reaction chamber 120, a particle collector 130, and a sample collection bottle 140, for example. Specifically, the precursor solution PS is sent into the nozzle 110, and the precursor solution PS is atomized and sprayed into the reaction chamber 120 by the nozzle 110 so as to form the dried mixture powder DP in the reaction chamber 120. In the embodiments, a liquid feed rate of the nozzle 110 is about from 2 to 5 g/min, for example. In the embodiments, a spraying air pressure of the nozzle 110 is about from 3 to 5 kg/cm², for example. In the embodiments, a carrier gas CG continuously inflows and outflows the spray-drying device 100 so as to carry the atomized precursor solution PS. In the embodiments, the carrier gas CG is a compressed air, for example. In the embodiments, the reaction chamber 120 has a high temperature energy, for example, so that the dried mixture powder DP may react in the reaction chamber 120. In the embodiments, an inlet temperature of the reaction chamber 120 of the spray-drying device 100 is about from 150 to 300° C., for example. An outlet temperature of the reaction chamber 120 of the spray-drying device 100 is about from 105 to 150° C., for example. That is, a temperature of the atomized precursor solution PS entering the reaction chamber 120 is about from 150 to 300° C., for example. A temperature of the formed dried mixture powder DP departing from the reaction chamber 120 is about from 105 to 150° C., for example. In the embodiments, the carrier gas CG is a heated compressed air, for example. Thus, the required high temperature energy of the reaction chamber 120 is provided by injecting the carrier gas CG into the reaction chamber 120. In the embodiments, the product after reaction is collected in the sample collection bottle 140 by the particle collector 130. In the embodiments, the particle collector 130 is a bag dust collector, an electrostatic dust collector, or a cyclone dust collector, for example. The sample collection bottle 140 is a stainless steel container, for example. In the embodiments, the dried mixture powder DP is a Mn—Fe—Ti composite material, for example, which is a nanoparticle with uniform particle size.

After that, a calcination process is performed on the dried mixture powder DP so as to form a selective catalytic reduction composite catalyst powder. In the embodiments, the calcination process is performed in a high temperature furnace, for example. In the embodiments, a temperature of the calcination process is about from 350° C. to 550° C., for example. A time of the calcination process is about from 4 to 6 hours, for example. In the embodiments, a temperature of the calcination process is about 350° C., for example. In the embodiments, a time of the calcination process is about 6 hours, for example. In the embodiments, the selective catalytic reduction composite catalyst is, for example, a Mn—Fe—Ti selective catalytic reduction composite catalyst, such as Mn₂₀Fe₁₀—TiO₂. In the embodiments, a dimension of the formed selective catalytic reduction composite catalyst powder is about from 0.5 to 3 mm, for example, and a specific surface area thereof is about from 52 to 74 m²/g.

In the embodiments, a method of preparing the selective catalytic reduction composite catalyst is performed by the fast spray-drying technology without complicated and time-consuming preparation process. Specifically, a precursor including a first metal compound monomer, a second metal compound and a third metal compound is sprayed into droplets by high pressure and then injected into a reaction chamber for heating. Thereby, a dried solid powder is formed while water is evaporated quickly, and then the solid powder is separated from an air flow. Thus, a method of preparing the selective catalytic reduction composite catalyst has advantages, such as simple, fast, continuously produced, and low cost operating procedure, and also has potential for mass production. In the embodiments, the Mn—Fe—Ti selective catalytic reduction composite catalyst has a good nitrogen oxide denitrification efficiency at low temperature. The Mn—Fe—Ti composite catalyst is multi-functional and may be applied to the reduction of air pollutants, such as volatile organic chemicals (e.g. acetone, toluene, etc.) contained in exhaust air in the end of the tube (e.g. exhaust air released from steel plants or semiconductor plants) in the future. In addition, a method of preparing the selective catalytic reduction composite catalyst of the embodiments may be applied to the pharmaceutical industry, the cosmetics industry, the solar energy industry, the gas sensor, the micro-electromechanical industry, the printing industry, the stain/dye industry, and the like, to generate products, such as catalysts, drugs (directing agents), cosmetics, high intensity and high chroma pigments, ultra-toughness ceramic materials, and the like.

In the following, the features of the selective catalytic reduction composite catalyst manufactured by a method of preparing the same of the present disclosure are illustrated with reference to examples and comparative examples.

### EXAMPLE

### A method of Preparing a Titanium Oxide Support

First, a titanium oxide hydrate (TiO(OH)₂) powder, water, and ammonia were stirred and mixed at normal temperature and pressure so as to form a titanium oxide precipitate. Then, suction filtration was performed on the titanium oxide precipitate which was also washed by deionized water several times so as to obtain the titanium oxide support.

### Covering Ferromanganese Oxide on the Titanium Oxide Support by a Spray-Drying Process

First, the washed titanium oxide support was mixed with the manganese aqueous solution with different concentrations (5 wt %, 10 wt %, 15 wt %, 20 w t%, 25 wt % and 30 wt %), the ferric nitrate aqueous solution with different concentrations (5 wt %, 10 wt %, 15 wt % and 20 wt %), and the deionized water solution, so that a solid-to-liquid ratio thereof was 1:10. Then, the mixed liquid was uniformly stirred so as to form a precursor solution. Next, the precursor solution was atomized by a nozzle of a spray-drying device so as to inject the precursor solution into a reaction chamber, wherein a compressed air was used as a carrier gas. The carrier gas was heated, thereby providing the required high temperature energy to the reaction chamber after injecting thereinto. After that, the product in the reaction chamber after reaction was collected in a sample collection bottle by a particle collector. Then, the collected powder was placed in a high temperature furnace and calcinated at

### Comparative Example 1

To prepare the Mn—Fe—Ti composite catalyst having the same ratio of titanium, manganese, and iron compared to the product derived from Example by a coprecipitation method.

### Comparative Example 2

To prepare the Mn—Fe—Ti composite catalyst having the same ratio of titanium, manganese, and iron compared to the product derived from Example by a wet impregnation method.

### Comparative Example 3

To prepare the Mn—Fe—Ti composite catalyst having the same ratio of titanium, manganese, and iron compared to the product derived from Example by a sol-gel method.

### NO Conversion Rate of the Mn—Fe—Ti Composite Catalyst

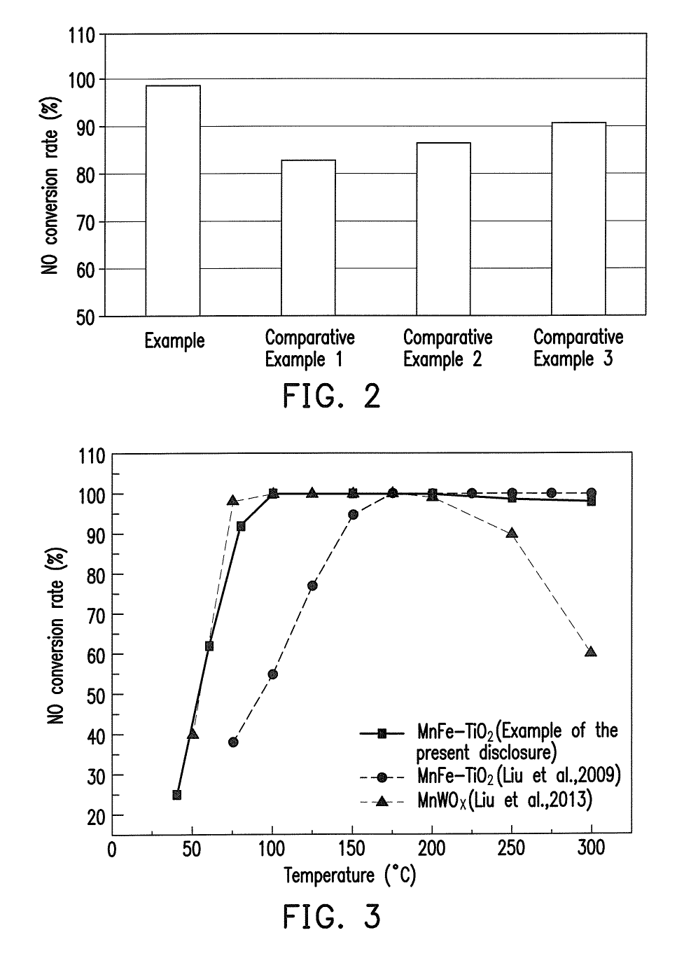

The selective catalytic reduction test is performed on the Mn—Fe—Ti composite catalysts derived from Example and Comparative Examples 1-3 respectively, wherein the test conditions include: NO (500 ppm), NH₃ (500 ppm), O₂ (5%), space flow rate (50000 h⁻¹), and reaction temperature (100° C.). The test results are shown in FIG. 2.

From FIG. 2, when the operating temperature is 100° C., the nitrogen oxide conversion rate of the Mn—Fe—Ti composite catalyst prepared by the spray-drying method of Example of the present disclosure may achieve about 99%, the nitrogen oxide conversion rate of the Mn—Fe—Ti composite catalyst prepared by the sol-gel method of Comparative Example 3 is about 91%, and the nitrogen oxide conversion rates of the Mn—Fe—Ti composite catalysts prepared by the wet impregnation method of Comparative Example 2 and the coprecipitation method of Comparative Example 1 are only 89% and 83% respectively. From this, the Mn—Fe—Ti composite catalyst prepared by the spray-drying method of Example of the present disclosure has a significant high nitrogen oxide conversion rate. That is, the Mn—Fe—Ti composite catalyst prepared by the spray-drying method of Example of the present disclosure has a better nitrogen oxide conversion rate compared to that prepared by other traditional methods.

In addition, comparing the catalyst of Example with the catalysts published by F. Liu research team in 2009 and 2013, the results are shown in FIG. 3. The catalyst published by Liu et al. in 2009 (shown as “Liu et al, 2009” in FIG. 3) is the MnFe—TiO₂ catalyst prepared by a precipitation method. The catalyst published by Liu et al. in 2013 (shown as “Liu et al, 2013” in FIG. 3) is the MnWOₓ pure metal catalyst (without support) prepared by a precipitation method. The operating conditions of the catalysts of Example of the present disclosure and published by Liu et al. are NO (500 ppm), NH₃ (500 ppm), O₂ (5%), space flow rate (50000 h⁻¹), and reaction temperature (100° C.). It should be noted that, F. Liu research team has published 28 papers about SCR denitrification catalyst on journal since 2008, wherein all SCR journal citations are more than 500 times. Whether the quality or quantity thereof has a certain level, and it can be said that the papers thereof are important indicators of the SCR catalyst.

From FIG. 3, the SCR denitrification efficiency of the MnFe—TiO₂ catalyst prepared by Liu et al. is lower than 80% in a low temperature zone (e.g. 75° C.-125° C.) while the SCR denitrification efficiency thereof increases to 80% at a temperature higher than 150° C. In another aspect, the denitrification efficiency of the MnWOₓ pure metal catalyst prepared by Liu et al. is close to 100% at 75° C. However, the MnWOₓ pure metal catalyst prepared by Liu et al. gradually becomes inactivated in a high temperature zone (200° C.-300° C.). The SCR denitrification efficiency thereof drops to 60% at 300° C. The denitrification efficiency of the Mn₂₀Fe₁₀—TiO₂ catalyst of Example of the present disclosure is similar to that of the MnWOₓ pure metal catalyst prepared by Liu et al. at low temperature, and the SCR denitrification efficiency thereof is as high as 92% at 80° C. In addition, the denitrification efficiency of the Mn₂₀Fe₁₀—TiO₂ catalyst of Example of the present disclosure maintains higher than 98% at the temperature ranging from 100° C. to 300° C. From this, in the aspects of the denitrification efficiency and the operating temperature range of the catalyst of Example of the present disclosure are better than that of the catalyst of F. Liu research team.

Based on the above descriptions, the method of preparing the selective catalytic reduction composite catalyst of the present disclosure is performed by the fast spray-drying technology without complicated and time-consuming preparation process. Specifically, the precursor solution including the first metal, the second metal and the third metal are sprayed into droplets by high pressure and then injected into the reaction chamber for heating. Thereby, the dried mixture solid powder is formed while water is evaporated quickly, and then the mixture solid powder is separated from the air flow. After that, the calcination process is performed on the mixture solid powder to form the selective catalytic reduction composite catalyst powder. Thus, the method of preparing the selective catalytic reduction composite catalyst has the advantages, such as a simple, fast, continuously produced, and low cost operating procedure, and also has potential for mass production. In addition, the selective catalytic reduction composite catalyst produced by the spray-drying technology of the present disclosure has a better efficiency compared to the selective catalytic reduction composite catalyst produced by the traditional methods, such as a copricipitation method, a wet impregnation method, a sol-gel method, and the like.

Although the present disclosure has been described with reference to the above embodiments, it is apparent to one of the ordinary skill in the art that modifications to the described embodiments may be made without departing from the spirit of the present disclosure. Accordingly, the scope of the present disclosure will be defined by the attached claims not by the above detailed descriptions.

What is claimed is:

1. A method of preparing a selective catalytic reduction composite catalyst, comprising:
mixing a first metal compound support, a second metal compound, a third metal compound, and water to form a precursor solution;
forming a dried mixture powder from the precursor solution by a spray-drying process; and
performing a calcination process on the dried mixture powder.

2. The method of preparing the selective catalytic reduction composite catalyst according to claim 1, wherein the selective catalytic reduction composite catalyst comprises a manganese-iron-titanium selective catalytic reduction composite catalyst.

3. The method of preparing the selective catalytic reduction composite catalyst according to claim 1, wherein the first metal compound support comprises a titanium oxide support.

4. The method of preparing the selective catalytic reduction composite catalyst according to claim 3, wherein the titanium oxide support comprises titanium hydroxide.

5. The method of preparing the selective catalytic reduction composite catalyst according to claim 3, wherein a method of forming the titanium oxide support comprises mixing water, a titanium oxide hydrated precursor, and ammonia.

6. The method of preparing the selective catalytic reduction composite catalyst according to claim 1, wherein the second metal compound comprises a manganese metal compound.

7. The method of preparing the selective catalytic reduction composite catalyst according to claim 1, wherein the second metal compound comprises manganese acetate.

8. The method of preparing the selective catalytic reduction composite catalyst according to claim 1, wherein the third metal compound comprises an iron metal compound.

9. The method of preparing the selective catalytic reduction composite catalyst according to claim 1, wherein the third metal compound comprises ferric nitrate.

10. The method of preparing the selective catalytic reduction composite catalyst according to claim 1, comprising using a spray-drying device to perform the spray-drying process, wherein the spray-drying device comprises a nozzle, a reaction chamber, a particle collector, and a sample collection bottle.

11. The method of preparing the selective catalytic reduction composite catalyst according to claim 10, wherein the nozzle is used for atomizing the precursor solution into the reaction chamber.

12. The method of preparing the selective catalytic reduction composite catalyst according to claim 11, further comprising injecting a carrier gas into the spray-drying device so as to carry the atomized precursor solution.

13. The method of preparing the selective catalytic reduction composite catalyst according to claim 12, wherein the carrier gas comprises a compressed air.

14. The method of preparing the selective catalytic reduction composite catalyst according to claim 11, wherein a spraying air pressure of the spray-drying device is about from 3 to 5 kg/cm².

15. The method of preparing the selective catalytic reduction composite catalyst according to claim 10, wherein an inlet temperature of the reaction chamber is about from 150 to 300° C.

16. The method of preparing the selective catalytic reduction composite catalyst according to claim 10, wherein an outlet temperature of the reaction chamber is about from 105 to 150° C.

17. The method of preparing the selective catalytic reduction composite catalyst according to claim 10, wherein a liquid feed rate of the nozzle is about from 2 to 5 g/min.

18. The method of preparing the selective catalytic reduction composite catalyst according to claim 1, wherein a ratio of a solid content to water of the precursor solution is about 1:10.

19. The method of preparing the selective catalytic reduction composite catalyst according to claim 1, wherein a temperature of the calcination process is about 350° C.

20. The method of preparing the selective catalytic reduction composite catalyst according to claim 1, wherein a dimension of the selective catalytic reduction composite catalyst is about from 0.5 to 3 mm, and a specific surface area thereof is about from 52 to 74 m²/g.
